(19) United States
(12) Patent Application Publication
(10) Pub. No.: US 2025/0109951 A1
(43) Pub. Date: Apr. 3, 2025

(54) EMERGENCY NAVIGATIONAL PATHING

(71) Applicant: T-Mobile Innovations LLC, Overland Park, KS (US)

(72) Inventor: Kade SCOTT, McKinney, TX (US)

(21) Appl. No.: 18/480,081

(22) Filed: Oct. 3, 2023

(51) Int. Cl. G01C 21/34; H04W 4/90

(52) U.S. Cl. CPC G01C 21/3461; H04W 4/90

(57) ABSTRACT

Systems, methods and devices are provided for sensing a trigger event and receiving, at an emergency navigational pathing system, a notification of a trigger event from at least one sensor. Based on the notification, the system determines an impacted area and formulates at least one navigational path based on the determination of the impacted area. The system further transmits at least one formulated navigational path to a navigation system.

### TECHNICAL BACKGROUND

Emergency events, such as shootings, fires, floods, storms, and others can wreak havoc on infrastructure. The events can cause roads to close, create traffic backups, and endanger the lives and well- of those entering the area impacted by the emergency event. Further, such events can pose increasing danger when emergency personnel are unable to reach the impacted areas due to excessive traffic or lack of awareness of the impacted location.

With the omni-presence of wireless devices, a wireless network, such as a cellular network can be utilized to spread information about emergency events Wireless networks can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)) and 6G RATs. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs

Accordingly, a need exists for leveraging and improving upon the existing wireless infrastructure to spread awareness and appropriately direct traffic based on knowledge of the area impacted by the emergency event.

### Overview

Exemplary embodiments described herein include systems, methods, and processing nodes for emergency navigational pathing. An exemplary method includes receiving, at an emergency navigational pathing system, a notification of a trigger event from at least one sensor. Based on the notification, the method includes determining an impacted area and formulating at least one navigational path based on the determination of the impacted area. The method further includes transmitting the at least one navigational path to a navigation system.

Further exemplary embodiments include a system for emergency navigational pathing. The system includes at least one sensor sensing a trigger event and causing transmission of a notification of the trigger event. The system additionally includes a processing node including a memory, a processor, and a transceiver. The transceiver receives the notification of the trigger event caused by the sensor. The processor accesses the memory and executes the stored instructions to perform multiple operations. The operations include determining an impacted area based on the notification and formulating at least one navigational path based on the impacted area. The operations further include transmitting the at least one navigational path to a navigation system.

In yet a further exemplary embodiment, a non-transitory computer readable medium is provided. The non-transitory computer-readable medium stores instructions executed by a processor to perform multiple operations. The operations include receiving a notification of a trigger event from at least one sensor and determining an impacted area based on the notification. The operations further include formulating at least one navigational path based on the impacted area and causing the at least one navigational path to be transmitted to a navigation system.

### BRIEF DESCRIPTION OF THE DRAWINGS

FIG. 1 depicts an exemplary operating environment for emergency navigational pathing in accordance with the disclosed embodiments.

FIG. 2 illustrates an additional exemplary operating environment for an emergency navigational pathing system in accordance with disclosed embodiments.

FIG. 3 illustrates an exemplary configuration for an emergency navigational pathing system in accordance with disclosed embodiments.

FIG. 4 depicts an exemplary access node in accordance with disclosed embodiments.

FIG. 5 depicts an exemplary method for emergency navigational pathing in accordance with disclosed embodiments.

FIG. 6 depicts a further exemplary method for emergency navigational pathing in accordance with disclosed embodiments.

FIG. 7 depicts a further exemplary method for emergency navigational pathing in accordance with disclosed embodiments.

### DETAILED DESCRIPTION

Exemplary embodiments described herein include systems and methods for emergency navigational pathing for directing various types of traffic based on an impacted area during an emergency event. The types of traffic may, for example, include autonomous vehicles, such as terrestrial vehicles including self-driving cars. The types of traffic may further include aerial or celestial traffic such as drones, or other flying vehicles. The types of traffic may further include aquatic traffic, such as boats, ships or submarines. Any of these types of traffic may be self-guided or autonomous, or alternatively may include a navigation system for display to a driver passenger. However, embodiments provided herein are particularly applicable to autonomous vehicles that utilize navigational pathing to get from one location to another and aim to avoid areas impacted by emergencies. However, in some embodiments, the autonomous vehicles may be first responder vehicles that aim to most quickly reach an area impacted by an emergency event.

In embodiments provided herein, the emergency event may be one of or a combination of multiple types of events, such as, for example active shooting scenarios, natural disasters, vehicle collisions or crashes or other road blockages, plane crashes, etc. Natural disasters may include, for example, floods, wildfires, hurricanes, tornados, etc. Various types of sensors may be included in or may communicate with the system described herein in order to detect these emergency events.

The detected emergency event functions as a trigger event leading to re-pathing such that an autonomous vehicle can be automatically re-pathed. Thus, systems and methods are provided for automated navigational pathing, which is particularly applicable to autonomous vehicles. The method is initialized by sensing of a trigger event. The sensors may then notify all applicable access nodes within a triangulated area. Any number of trigger events or applicable access nodes may be integrated in the system. Systems and methods provided herein enable GPS systems and navigational pathing processes to re-path around a geofenced area.

Further, it should be noted that various types of sensors could be utilized in order to sense the trigger event. For example, the sensors may be acoustical detectors, cameras, heat sensors, smoke sensors, or other types of sensors. The sensors may be independently located or may be integrated with an access node or other system component.

The emergency navigational pathing may be determined based on an area impacted by the emergency event. Thus, in embodiments provided herein, the impacted area is determined based on data transmitted by the sensors as well as GPS and cellular location data. Further, the impacted area may be determined through known triangulation procedures. An emergency navigational path is determined for a given vehicle through knowledge of the vehicle's current location, ultimate destination, and the impacted area. The emergency navigational pathing system draws from existing geographic knowledge, knowledge of the impacted area, and vehicle location and destination to determine an emergency navigational path. Accordingly, methods provided herein include receiving a notification of a trigger event from at least one sensor, determining an impacted area based on the notification, and formulating at least one navigational path based on the impacted area. Methods provided herein further cause the navigational path to be transmitted to a navigation system.

In embodiments described herein, processing tasks may be performed at a core network or closer to the cellular customer in order to respond to emergencies more quickly. For example, embodiments disclosed herein may be implemented the cellular base stations or other edge nodes. Through the use of systems, methods, and devices described herein, navigational systems can be updated automatically in response to emergency event detection procedures.

In addition to the systems and methods described herein, the operations for emergency re-pathing may be implemented as computer-readable instructions or methods, and processing nodes on the network for executing the instructions or methods. The processing node may include a processor included in the access node or a processor included in any controller node in the wireless network that is coupled to the access node.

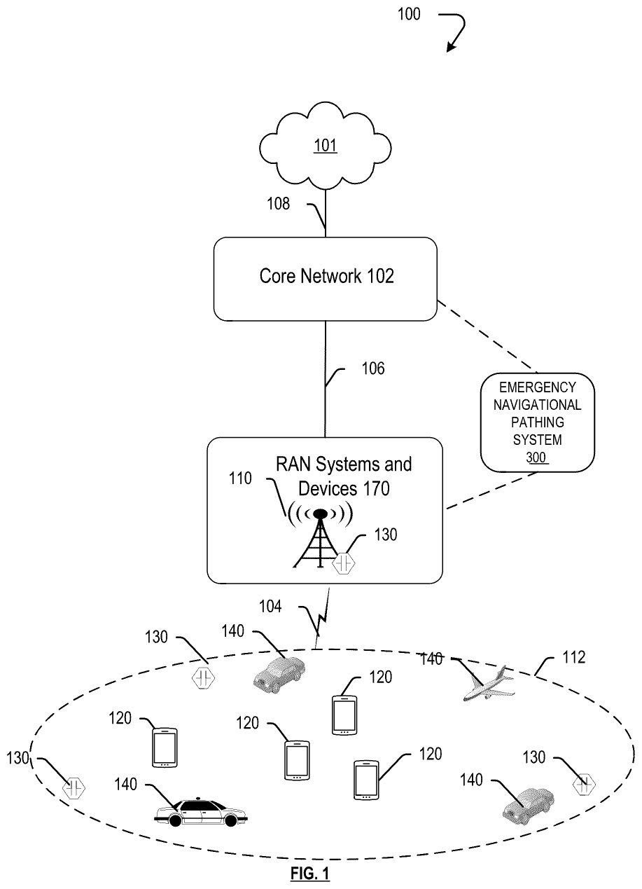

FIG. 1 depicts an exemplary environment 100 for emergency navigational pathing in accordance with the disclosed embodiments. The environment 100 may include a communication network 101, a core network 102, and a radio access network (RAN) 170, including at least one access node 110. The core network 102 is connected to the communication network 101 over communication link 108. The RAN 170 may include other devices and additional access nodes and further may include one or more sensors 130. The environment 100 also includes multiple wireless devices 120 which may be end-user wireless devices and may operate within one or more coverage areas 112 and communicate with the RAN 170 over communication link 104, which may for example be a 5G NR and/or 4G LTE communication link.

The environment 100 may further include an emergency navigational pathing system 300, which is illustrated as operating between the core network 102 and the RAN 170. However, it should be noted that the emergency navigational pathing system 300 may be distributed. For example, the emergency navigational pathing system 300 may utilize components located at the core network 102 and at one or more multiple access nodes 110. Alternatively, the emergency navigational pathing system 300 may be an entirely discrete component, such as a processing node, operating between the core networks 102 and the RAN 170.

The emergency navigational pathing system 300 receives information pertaining to emergency events from sensors 130 dispersed throughout a coverage area. In some embodiments, sensors 130 may be affixed to the access node 110 or to any access node within the system. Based on data received from the sensors 130. the emergency navigational pathing system 300 performs processing steps to identify an impacted area and perform emergency navigational pathing for multiple devices such as wireless devices 120, and vehicles 140. The sensors 130 may be considered to be part of the emergency navigational pathing system 300 or may be considered as separate components interacting with the emergency navigational pathing system 300.

The sensors 130 may be or include acoustic sensors, heat sensors, flow sensors, weather sensors, cameras, smoke sensors, or any other type of sensor. The vehicles 140 may be or include autonomous vehicles, driver-controlled vehicles, aerial vehicles, terrestrial vehicles, aquatic vehicles, or other types of vehicles.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120 and to support communications to and from sensors 130 and vehicles 140. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. Thus, the converged core gateway could connect a 4G LTE evolved packet core (EPC) to a 5G core network.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), Si, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access node 110 and sensor 130. The RAN 170 is disposed between the core network 102 and the end-user wireless devices 120, sensors 130, and vehicles 140. Components of the RAN 170 may communicate directly with the core network 102 and others may communicate directly with the end user wireless devices 120, vehicles 140, and sensors 130. The RAN 170 may provide services from the core networks 102 to the end-user wireless devices 120.

The RAN 170 includes at least an access node (or base station) 110 such as an eNodeB of gNodeB 110 communicating with the plurality of end-user wireless devices 120, sensors 130, and vehicles 140. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 110 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 110 may comprise a short range, low power, small-cell access node such as a microcell access node, a picocell access node, a femtocell access node, or a home eNodeB device. As will be further described below, functionality for emergency navigational pathing may be included within the access nodes. Access node 110 can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110 can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Furthermore, in embodiments set forth herein, the access nodes 110 are able to interact with the emergency navigational pathing system 300 for formulating navigational paths upon detection of a triggering emergency event.

The wireless devices 120 may include any wireless device included in a wireless network. For example, the term “wireless device” may include a relay node, which may communicate with an access node. The term “wireless device” may also include an end-user wireless device, which may communicate with the access node in the access network 170 through the relay node. The term “wireless device” may further include an end-user wireless device that communicates with the access node directly without being relayed by a relay node.

Wireless devices 120 may be any device, system, combination of devices, or other such communication platform capable of communicating wirelessly with access network 110 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

Environment 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 120. Environment 100 may include additional base stations, controller nodes, telephony switches, internet routers, network gateways, computer systems, communication links, or other type of communication equipment, and combinations thereof.

Other network elements may be present in the environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access networks 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication environment100 may be, comprise, or include computers systems and/or processing nodes, including access nodes, controller nodes, and gateway nodes described herein.

The operations for emergency navigational pathing may be implemented as computer-readable instructions or methods, and processing nodes on the network for executing the instructions or methods. The processing node may include a processor included in the access node or a processor included in any controller node in the wireless network that is coupled to the access node.

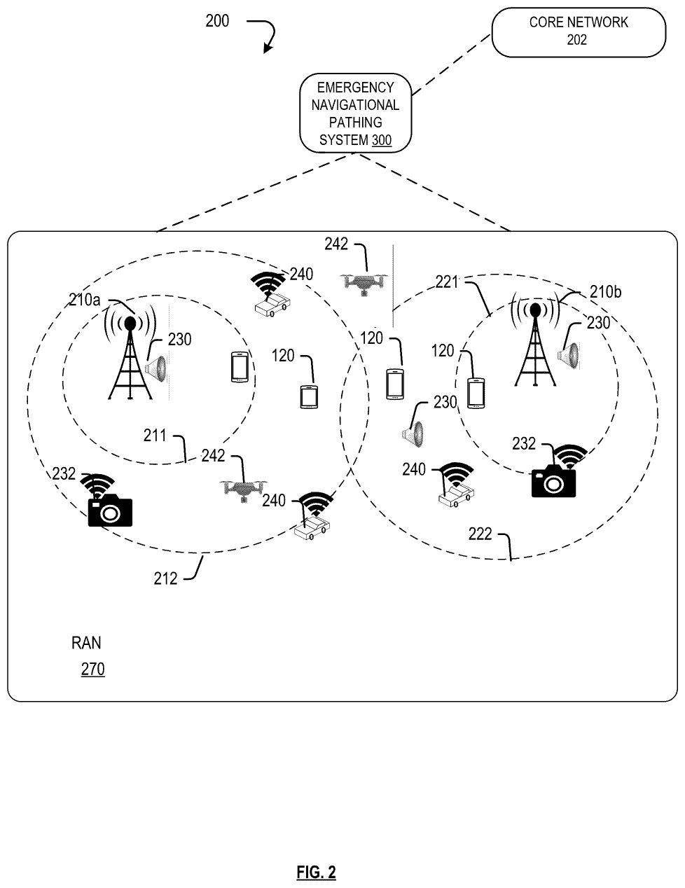

FIG. 2 depicts a further exemplary operating environment 200 for an emergency navigational pathing system 300 in accordance with the disclosed embodiments. The operating environment may include a RAN 270 including access nodes 210a and 210b, which may include a gNB and/or eNB. Wireless devices 120 may communicate over the RAN 270. The wireless devices 120 may be end-user wireless devices and may operate within one or more coverage areas 211, 212, 221, and 222 of the access nodes 210a and 210b.

While like reference numbers may refer to the elements described above with respect to FIG. 1, the environment 200 may include additional nodes similar to access nodes 210a and 210b. Further, these access nodes 210a and 220b may each operate within two different RATs and may thus each have two different coverage areas 211, 212, 221, and 222. For example, coverage area 211 may be a 5G coverage area of access node 210a and coverage area 212 may be a 4G LTE coverage area of the access node 210a. Further, a coverage area 221 may be a 5G coverage area of access node 210b and coverage area 222 may be a 4G LTE coverage area of access node 210b. As illustrated, the access nodes 210a and 210b may serve multiple wireless devices 120, and vehicles 240 and 242. Further, multiple types of sensors 230 and 232 may communicate with the access nodes 210a and 210b and multiple types of autonomous vehicles 240, 242 may communicate with the access nodes 210a, 210b.

The sensors 230 and 232 may include, for example, cameras and acoustic sensors in the described embodiment, but many other types of sensors such as heat sensors, flow sensors, weather sensors, etc., may be utilized. The sensors 230 are shown as being affixed to the access nodes 210a and 210b, which may be or include mobile network towers. The sensors 230 and 232 may however, be partially affixed, or may be strategically geographically dispersed in order to sense trigger events. The sensors 230, 232 may be sensor arrays encompassing an expansive geographical area. The trigger events may, for example, be emergencies having a magnitude reaching a predetermined threshold.

In a described embodiment, automated emergency navigational pathing starts when a trigger event is sensed by the sensor/sensor array 230, 232 that can be affixed to a mobile network tower, partially affixed, or locally within range, such that when triggered, causes the mobile network to notify all applicable access nodes within a certain area.

Infrastructure for performing the method may be available through schools, companies, churches, parks, city services, etc. For example, these institutions may have acoustic detectors 230 capable of being used in triangulating the location of a shooting event when a firearm is discharged. When the acoustical detector 230 is triggered by the sound of gunfire, then the cell tower or access node 210a, 210b receives the trigger notification and automatically notifies all pertinent access nodes across its mobile network and generates a location to avoid that all nodes will reroute around. This process will directly fill the gap that exists today where emergency management teams and local law enforcement need to cordon off an impacted location but are unable to modify GPS systems. As ariel, terrestrial, aquatic, and/or celestial vehicle systems 240, 242 become more autonomous, this process is configured to ensure that individuals are able to get to their preferred location without interfering with emergency investigations.

In yet a further example, wildfire detection equipment uses a camera system or camera array 232 for detecting a wildfire in order to reroute individuals away from potential danger. Danger could be assessed directly, such as when a fire is accurately present, and/or assessed based on the estimation of where a fire might be spreading utilizing and artificial intelligence (AI) or machine learning (ML) estimate.

In yet another embodiment, a system combines a plurality of sensors, systems, and tools across a relatively large region. For example, weather related sensors may sense a hurricane, tsunami, tornado, etc. The sensors may be utilized by local governments, federal governments, private agencies and/or amateur agencies to instigate impact and area of destruction estimation by the tools described herein. The impact and area of destruction may be automatically calculated by one or a plurality of systems including but not limited ML, AI, deep learning, etc., causing the automatic emergency navigational pathing to occur.

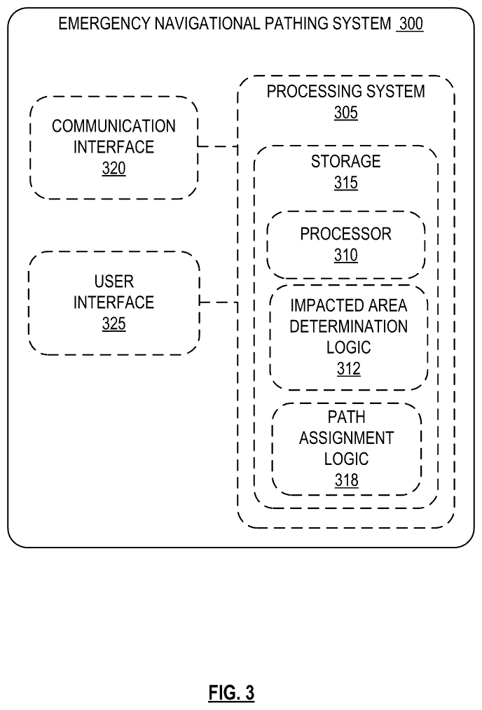

The emergency navigational pathing system 300 may be a separate component that communicates with the access nodes 210a and 210b and may also communicate with the core network 202. The emergency navigational pathing system 300 may be substantially as described herein with respect to FIG. 3 and may control emergency navigational pathing for autonomous vehicles 240, 242 based on data supplied by sensors 230, 232. In yet further embodiments, the emergency navigational pathing system 300 may provide emergency navigational pathing to wireless devices 220 when the wireless devices 220 access a navigational application.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication systems 100 or 200 may be, comprise, or include computers systems and/or processing nodes, including access nodes, controller nodes, and gateway nodes described herein.

FIG. 3 depicts an exemplary emergency navigational pathing system 300, which may be configured to perform the methods and operations disclosed herein to provide emergency navigational pathing. In the disclosed embodiments, the emergency navigational pathing system 300 may be integrated with the access nodes 110, 210a, 210b, the core network 102, 202 or may be an entirely separate component, such as a processing node, capable of communicating with the access nodes 110, 210a, 210b, core network 102, 202 and the wireless devices 120, 220, the sensors 130, 230, 232, and the vehicles 140, 240, 242.

The emergency navigational pathing system 300 may be configured to appropriately direct vehicles and pedestrians in the event of an emergency. To provide appropriate emergency navigational pathing, the emergency navigational pathing system 300 may include a processing system 305. Processing system 305 may include a processor 310 and a storage device 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include one or more modules for performing various operations described herein. For example, instructions 312 may be provided to determine an area impacted by an emergency based on data provided by the above-described sensors. Further, instructions 318 may include path assignment logic for assigning an emergency navigational path based on the determined impacted area. For example, the path assignment logic 318 may be utilized to determine a path for an emergency responder attempting to reach the emergency and to further determine a path for ordinary commuters attempting to avoid the emergency. Processor 310 may be a microprocessor and may include hardware circuitry and/or embedded codes configured to retrieve and execute software stored in storage device 315.

The emergency navigational pathing system 300 may include a communication interface 320 and a user interface 325. Communication interface 320 may be configured to enable the processing system 305 to communicate with other components, nodes, or devices in the wireless network. For example, the emergency navigational pathing system 300 can share intelligence with the access nodes 110, 210a, and 210b.

Communication interface 320 may include hardware components, such as network communication ports, devices, routers, wires, antenna, transceivers, etc. These components may, for example, receive notifications of trigger events from the above-described sensors 130, 230, 232. User interface 325 may be configured to allow a user to provide input to the emergency navigational pathing system 300 and receive data or information from the emergency navigational pathing 300. User interface 325 may include hardware components, such as touch screens, buttons, displays, speakers, etc. The emergency navigational pathing system 300 may further include other components such as a power management unit, a control interface unit, etc.

The emergency navigational pathing system 300 thus may utilize the memory 315 and the processor 310 to perform multiple operations. For example, the processor 310 may access stored instructions in the memory 315 to determine a number that a trigger event has occurred, to determine an area impacted by an emergency, and to determine an emergency path based on an impacted area.

The location of the emergency navigational pathing system 300 may depend upon the network architecture. For example, in smaller networks, a single emergency navigational pathing system 300 may be disposed for communication with wireless devices, vehicles, sensors, and access nodes shown in FIGS. 1 and 2. However, in a larger network, multiple emergency navigational pathing system 300 may be required to cover the network. Further, the functions of the emergency navigational pathing system 300 may be split between the core network 102, 202 and the RAN 170, 270.

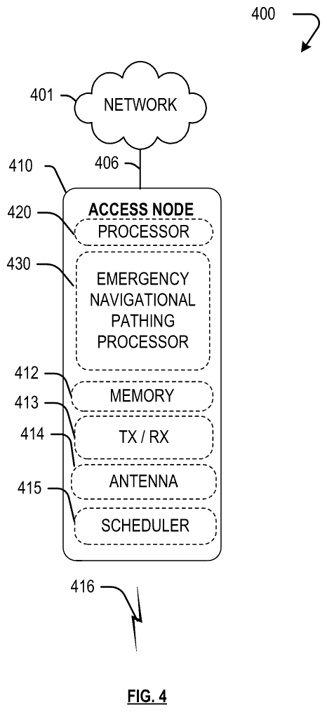

FIG. 4 illustrates an operating environment 400 for an exemplary access node 410 in accordance with the disclosed embodiments. In exemplary embodiments, the access node 410 is able to interact effectively with the emergency navigational pathing system 300 to minimize excess traffic around emergencies, to appropriately direct autonomous vehicles, other vehicle navigation systems, and pedestrians around the emergency, and further to provide emergency responders with a direct path to reach the emergency.

The access node 410 can include, for example, a gNodeB or an eNodeB or a co-located eNB/gNB. Access node 410 may comprise, for example, a macro-cell access node, such as access node 110, 210a, 210b described with reference to FIGS. 1 and 2. Access node 410 is illustrated as comprising a processor 420, an emergency navigational pathing processor 430, a memory 412, transceiver(s) 413, and antenna(s) 414. Processor 420 executes instructions stored on memory 412, while transceiver(s) 413 and antenna(s) 414 enable wireless communication with other network nodes, such as wireless devices and other nodes. For example, wireless devices may initiate uplink transmissions such that the transceivers 413 and antennas 414 receive messages including, for example, route information and performance parameters from the wireless devices, for example, over communication links 416 and 418. The transceivers 413 and antennas 414 may further pass the messages to a mobility entity in the core network. Further, the transceivers 413 and antennas 414 receive signals from the mobility entity such as a mobility management entity (MME) or access and mobility function (AMF) and pass the messages to the appropriate wireless device or navigation system. Scheduler 415 may be provided for scheduling resources based on the presence and performance parameters of the wireless devices as well as based on policies transmitted from the core network 102, 202. Network 401 may be similar to the network 101 discussed above with respect to FIG. 1.

In embodiments provided herein, processor 420 may operate in conjunction with scheduler 415 and emergency navigational pathing processor 430 to ensure timely and accurate emergency navigational pathing. In operation, the emergency navigational pathing processor 430 may be integrated with the processor 420 or alternatively may comprise logic stored in the memory 412 to execute emergency navigational pathing procedures. For example, the emergency navigational pathing processor 430 may receive instructions from the emergency navigational pathing system 300 and may provide the received instructions to the wireless devices 120, 220 and navigation systems in the vehicles 140, 240, 242.

While the processor 420 and the emergency navigational pathing processor 430 are shown as separate components, these components may optionally be integrated in various combinations. For example, the processor 420 may perform the functions described above with respect to the emergency navigational pathing processor 430 by accessing stored instructions from the memory 412. The access node 410 may utilize transceivers 413 and antennas 414 to communicate information, for example with the wireless devices 120, the sensors 130, 230, 232, and the vehicles and their navigation systems 140, 240, 242.

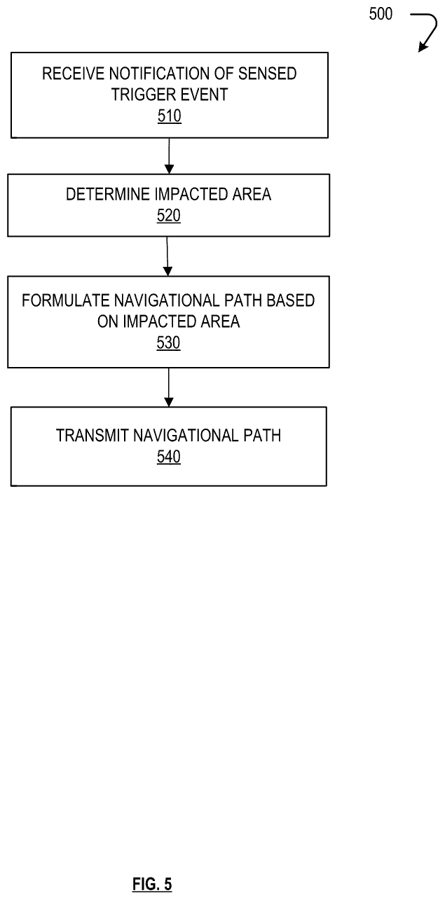

The disclosed methods for emergency navigational pathing are discussed further below. FIG. 5 illustrates an exemplary method 500 for emergency navigational pathing. Method 500 may be performed by any suitable processor discussed herein, for example, the processor 310 included in the emergency navigational pathing system 300. For discussion purposes, as an example, method 500 is described as being performed by the processor 310 of the emergency navigational pathing system 300.

Method 500 begins in step 510, when the emergency navigational pathing system 300 receives notification of a trigger event. The trigger event may be detected by any of the sensors or sensor arrays 130, 230, 232 described above with reference to FIGS. 1 and 2. Thus, the sensors or sensor arrays 130, 230, 232 may be capable of detecting gun shots, fires, flooded roads, storm warnings, traffic accidents, plain crashes, or other types of emergencies.

The sensors 130, 230, 232 may automatically notify the emergency navigational pathing system 300 of the detected emergency. The emergency navigational pathing system may, for example, be affixed to an access node or base station 110, 210a, 210b. and may receive the notification from the access node 110, 210a, 210b, or directly from a sensor or sensor array 130, 230, 232. Further, as described above, the emergency navigational pathing system 300 may be integral with or in direct communication with access nodes 110, 210a, 210b. In some embodiments, the emergency navigational pathing system 300 may be affixed to each access node 110, 210a, 210b. Further, the sensors 130, 230, 232 may be dispersed in many locations, but may also be affixed to the access nodes 110, 210a, 210b. In any case, the sensors 130, 230, 232 are within a coverage area of the access nodes 110, 210a, 210b and can transmit location data, which in some instances may be GPS coordinates, to the access nodes 110, 210a, 210b. The sensors 130, 230, 232 may be or include, for example, an acoustic sensor, a camera, a heat sensor, a smoke sensor, or a leak sensor, or any other type of sensor. The notifications from the sensors 130, 230, 232, may be received, for example, at a transceiver of the emergency navigational pathing system 300.

In embodiments set forth herein, upon receiving the notification in step 510, the emergency navigational pathing system 300 determines the impacted area in step 520. The determination of the impacted area in step 520 may be based on the location of the sensors 130, 230, 232, as well as algorithms accepting data from the sensors 130, 230, 232 as input. The data may include, for example, the magnitude of the trigger event and a location of the sensor 130, 230, 232. The method of claim 1, further comprising determining the impacted area using cellular triangulation.

In some embodiments, multiple sensors 130, 230, 232 may report their locations and detected magnitudes of the trigger event to the emergency navigational pathing system 300. Additionally location of the sensors may be stored. Further, the location of the trigger event may be determined, for example by geo-location, cellular triangulation, or by receiving coordinates from GPS enabled wireless devices and sensors.

For example, two sensors at different locations may report water depth and their locations to the emergency navigational pathing system 300. Thus, the emergency navigational pathing system 300 utilizes a stored algorithm to determine an impacted area based on this received information. Similar information may be sent in the event of a fire. For example, heat sensors may report temperature in addition to their respective locations. In the case of a tornado, multiple sensors may report wind speed as well as their respective locations to the emergency navigational pathing system 300. The emergency navigational pathing system 300 utilizes this information to determine the impacted area.

In step 530, the emergency navigational pathing system 300 utilizes the determination of the impacted area from step 520 to formulate a navigational path based on the impacted area. When the navigational path is terrestrial, the path provided may include a specific road map.

In step 540, the emergency navigational pathing system 300 transmits the formulated emergency navigational path to navigational systems of vehicles 140, 240, 242 and wireless devices 120, 220 as needed. As set forth above, the vehicles 140, 240, 242 may be terrestrial, aquatic, or aerial. Further the vehicles may be autonomous or human controlled. Additionally, the vehicles may be emergency vehicles or non-emergency vehicles. In any case, the formulated paths are installed to navigation systems of the vehicles and/or wireless devices and are utilized to direct most vehicles and pedestrians around the impacted area, but may also be utilized to direct emergency personnel to the impacted area.

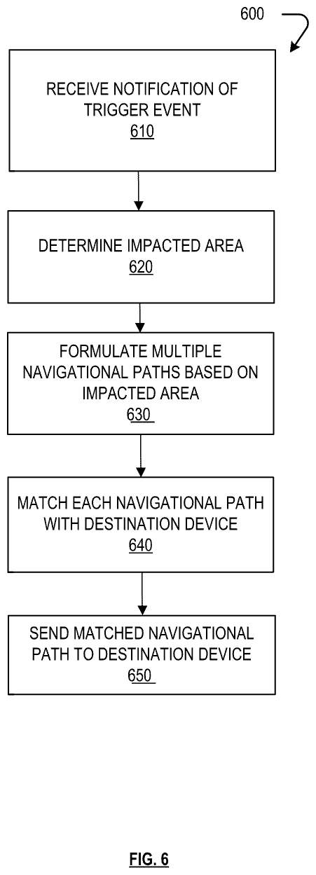

The disclosed methods emergency navigational pathing are discussed further below. FIG. 6 illustrates a further exemplary method 600 for emergency navigational pathing. Method 600 may be performed by any suitable processor discussed herein, for example, a processor 310 included in the emergency navigational pathing system 300. For discussion purposes, as an example, method 600 is described as being performed by the processor 310 of the emergency navigational pathing system 300.

Method 600 begins in step 610, when the emergency navigational pathing system 300 receives notification of a trigger event. The trigger event may be detected by any of the sensors or sensor arrays 130, 230, 232 described above with reference to FIGS. 1 and 2. Thus, the sensors or sensor arrays 130, 230, 232 may be capable of detecting gun shots, fires, flooded roads, storm warnings, traffic accidents, plain crashes, or other types of emergencies.

The sensors 130, 230, 232 may automatically notify the emergency navigational pathing system 300 of the detected emergency. The emergency navigational pathing system may, for example, be affixed to an access node or base station 110, 210a, 210b. and may receive the notification from the access node 110, 210a, 210b, or directly from a sensor or sensor array 130, 230, 232. Further, as described above, the emergency navigational pathing system 300 may be integral with or in direct communication with access nodes 110, 210a, 210b. In some embodiments, the emergency navigational pathing system 300 may be affixed to each access node 110, 210a, 210b. Further, the sensors 130, 230, 232 may be dispersed in many locations, but may also be affixed to the access nodes 110, 210a, 210b. In any case, the sensors 130, 230, 232 are within a coverage area of the access nodes 110, 210a, 210b and can transmit location data, which in some instances may be GPS coordinates, to the access nodes 110, 210a, 210b. The sensors may be or include, for example, an acoustic sensor, a camera, a heat sensor, a smoke sensor, or a leak sensor, or any other type of sensor.

In step 620, the emergency navigational pathing system determines an impacted area. The determination of the impacted area in step 520 may be based on the location of the sensors 130, 230, 232, as well as algorithms accepting data from the sensors 130, 230, 232 as input. The data may include, for example, the magnitude of the trigger event and a location of the sensor 130, 230, 232. The impacted area may be determined, for example, using cellular triangulation.

In some embodiments, multiple sensors 130, 230, 232 may report their locations and detected magnitudes of the trigger event to the emergency navigational pathing system 300. Additionally location of the sensors may be stored or may be determined, for example by geo-location, triangulation, receiving coordinates from GPS enabled wireless devices and sensors.

In step 630, the emergency navigational pathing system 300 formulates multiple navigational paths based on the impacted area as well as the requesting navigation system. The emergency navigational pathing system 300 may form multiple navigational paths intended for different targets. For example, the emergency navigational pathing system 300 may formulate a navigational path for emergency vehicles which sends the emergency vehicles directly to the impacted area. The same navigational path may be utilized for autonomous emergency vehicles. Since the vehicles may be aquatic, terrestrial, or aerial, the formulated emergency paths may further be differentiated on this basis. The emergency navigational pathing system 300 may further form a navigational path for autonomous vehicle navigational systems installed in autonomous passenger vehicles that are not emergency vehicles. The same navigational path may be utilized for passenger driven automobiles. Likewise, an additional navigational path may be developed for pedestrians and may be transmitted to wireless devices 120 utilized by pedestrians These navigational paths would be intended to direct the autonomous vehicle around the impacted area in order to avoid the impacted area entirely. The formulated navigational paths would be aimed at having the pedestrians avoid the impacted area.

In step 640, the processor 310 matches each navigational path with a destination device. For example, the processor 310 may receive requests from navigational systems, determine the type of navigational system, (such as emergency or non-emergency, pedestrian, terrestrial, aerial, or aquatic) and match a formulated path with the type of navigation system. For example, for a coast guard vehicle navigation system, the processor 310 may determine the type of navigation system to be an aquatic emergency personnel navigation system. Thus the processor 310 assigns a route formulated to immediately reach the impacted area by water to the requesting navigation system. In other instances, for example, for non-emergency autonomous terrestrial vehicles, the processor may match a formulated route using roads to avoid the impacted area.

In step 650, the emergency navigational pathing system 300 sends the matched path to a navigation system or application of a destination device. The assignment may occur when the processor 310 sends an instruction to a serving access node 110, 210a, 210b. In some instances, the transmission of the path may occur automatically based on the sensing of the trigger event and in other cases, the transmission of a navigational request may be performed upon request by a user of a navigational system or by the navigational system itself.

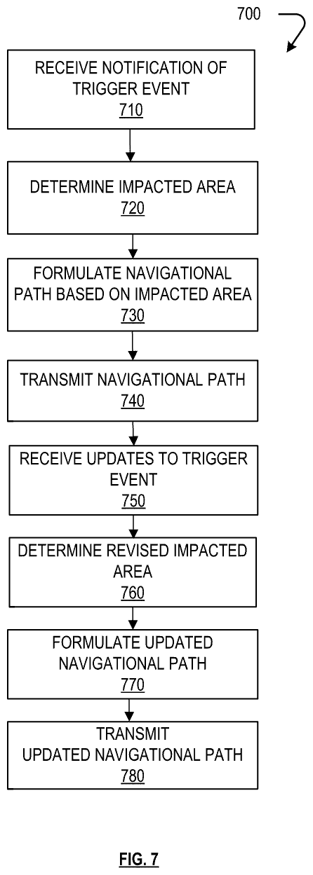

FIG. 7 illustrates an exemplary method 700 for emergency navigational pathing. In particular, FIG. 7 illustrates details of progressive updating of emergency navigational paths in accordance with disclosed embodiments. Method 700 may be performed by any suitable processor discussed herein, for example, a processor 310 included in emergency navigational pathing system 300. For discussion purposes, as an example, method 700 is described as being performed by the processor 310 of the emergency navigational pathing system 300.

Method 700 begins in step 710, when the emergency navigational pathing system 300 receives a notification of a trigger event from the sensors or sensor arrays 130, 230, 232. In step 720, based on the contents of the notification and the location of the sensors or sensor arrays 130, 230, 232, the emergency navigational pathing system 300 determines an impacted area. In some instances, multiple sensors or sensor arrays 130, 230, 232 may send a notification including a GPS location and different magnitudes. For example, the notification may include GPS coordinates of the sensors and indication of magnitude, such as a temperature in case of a fire, or a water level in case of a flood, or a number of shots in case of a shooting. Two different sensor arrays may report different locations and magnitudes. The greater the reported magnitude of the event and the further apart the notifying sensors, the larger the impacted area may become.

In step 720, based on stored algorithms accepting input including at least a sensor location and magnitude of the detected trigger event, the emergency navigational pathing system 300 determines an impacted area. The impacted area may be defined by a geo-fence outlining the impacted area. Thus, in step 730, the emergency navigational pathing system 300 formulates a navigational path based on the impacted area. As set forth above, the navigational path may be designed for an emergency responder to direct the emergency responder to the impacted area or may be designed for a non-emergency responder or ordinary commuter to avoid the impacted area. The formulated navigational path may be an aerial, terrestrial, or aquatic path.

In step 740, the emergency navigational pathing system 300 transmits the navigational path to the appropriate navigation system as described above. After transmission, in step 750, the emergency navigational pathing system 300 may receive updates to the previously received trigger event notifications. For example, the same reporting sensors may report the same location, but differing magnitudes. For example, in the case of a flood, one sensor array may report higher water than previously and another sensor may report a lower water level. In embodiments provided herein, the emergency navigational pathing system 300 thus receives a series of notifications of trigger events over time, wherein each notification in the series provides further information pertaining to the same trigger event. Thus, in step 760, the emergency navigational pathing system 300 is able to determine a revised impacted area. The revised impacted area may be determined upon each notification in the series of notifications. The area may become larger, smaller, or may simply change its boundaries to shift in one direction or another.

Accordingly, in step 770, the emergency navigational pathing system 300 formulates an updated navigational path based on the updated impacted area. Finally, in step 780, the emergency navigational pathing system 300 transmits an updated navigational path in step 780 to a navigation system.

Further, in all of the aforementioned embodiments, the emergency navigational pathing system 300 determines an impacted area and formulates a navigation path based on the impacted area. The particular configuration for making decisions and formulating and transmitting the formulated path may depend on the location of the emergency navigational pathing system 300 within the network. For example, the emergency navigational pathing system 300 could be located both at the core network 102, 202 and closer to a network edge so that inquiries may be processed locally, but decision making occurs at the core network 102, 202.

In some embodiments, methods 500, 600, 700 may include additional steps or operations. Furthermore, the methods may include steps shown in each of the other methods. As one of ordinary skill in the art would understand, the methods 500, 600, 700 may be integrated in any useful manner and the steps may be performed in any useful sequence.

In some embodiments, methods 500, 600, and 700 may include additional or fewer steps or operations. Furthermore, the methods may include steps shown in each of the other methods. As one of ordinary skill in the art would understand, the methods 500, 600, and 700 may be integrated in any useful manner. Further, the order of the steps shown is merely exemplary and the order of steps may be rearranged in any useful manner.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
receiving, at an emergency navigational pathing system, a notification of a trigger event from at least one sensor;
based on the notification, determining an impacted area;
formulating at least one navigational path based on the determination of the impacted area; and
transmitting the at least one navigational path to a navigation system.

2. The method of claim 1, further comprising determining the impacted area using cellular triangulation.

3. The method of claim 1, wherein the trigger event is a road blockage.

4. The method of claim 1, wherein the trigger event is one of a shooting, a storm warning, a flooded road, a fire, a traffic accident, a plane crash.

5. The method of claim 1, further comprising formulating the at least one navigational path for an autonomous vehicle.

6. The method of claim 4, wherein the at least one navigational path avoids the impacted area.

7. The method of claim 1, further comprising formulating the at least one navigational path for an emergency vehicle, wherein the at least one navigational path directs the emergency vehicle to the impacted area.

8. The method of claim 1, further comprising receiving, at the emergency navigational pathing system, a series of notifications, each notification of the series providing further information pertaining to the trigger event.

9. The method of claim 8, further comprising revising the determination of the impacted area and the at least one navigational path based on each received notification in the series of notifications.

10. The method of claim 1, wherein the at least one sensor is at least one of an acoustic sensor, a camera, a heat sensor, a smoke sensor, or a leak sensor.

11. A system comprising:
at least one sensor sensing a trigger event and transmitting a notification of the trigger event; and
a processing node including a memory, a processor, and a transceiver, the transceiver receiving the notification of the trigger event from the sensor and the processor accessing the memory and executing stored instructions to perform operations including;
determining an impacted area based on the notification;
formulating at least one navigational path based on the impacted area; and
transmitting the at least one navigational path to a navigation system.

12. The system of claim 11, the operations further comprising determining the impacted area using cellular triangulation.

13. The system of claim 11, further comprising formulating the at least one navigational path for an autonomous vehicle.

14. The system of claim 13, wherein the at least one navigational path avoids the impacted area.

15. The system of claim 11, further comprising formulating the at least one navigational path for an emergency vehicle, wherein the at least one navigational path directs the emergency vehicle to the impacted area.

16. The system of claim 11, the operations further comprising receiving at the processing node, a series of notifications, each notification of the series providing further information pertaining to the trigger event.

17. The system of claim 16, the operations further comprising further comprising revising the determination of the impacted area and the at least one navigational path based on each received notification in the series of notifications.

18. A non-transitory computer-readable medium storing instructions executed by a processor to perform operations including:
receiving a notification of a trigger event from at least one sensor;
determining an impacted area based on the notification;
formulating at least one navigational path based on the impacted area; and
causing the at least one navigational path to be transmitted to a navigation system.

19. The non-transitory computer-readable medium of claim 18, the operations further comprising determining the impacted area using cellular triangulation.

20. The non-transitory computer-readable medium of claim 18, the operations further comprising formulating the at least one navigational path to avoid the impacted area and causing the at least one navigational path to be transmitted to a navigation system of an autonomous vehicle.
